(19) United States
(12) Patent Application Publication
(10) Pub. No.: US 2014/0019718 A1
(43) Pub. Date: Jan. 16, 2014

(54) VECTORIZED PATTERN SEARCHING

(71) Applicant: Shihjong J. Kuo, Hillsboro, OR (US)

(72) Inventor: Shihjong J. Kuo, Hillsboro, OR (US)

(21) Appl. No.: 13/545,819

(22) Filed: Jul. 10, 2012

(51) Int. Cl. G06F 9/30

(52) U.S. Cl. 712/200; 712/E09.016

(57) ABSTRACT

Embodiments of computer-implemented methods, systems, computing devices, and computer-readable media are described herein for vectorized searching for a pattern P within a set of data T, the pattern P having a length m. In various embodiments, the vectorized search may include a shift of a sliding window into T by a distance d that is greater than m on determination, based on one or more ordered vectorized comparisons of portions of P and T, that no potential match of P is found within the sliding window. In various embodiments, d and m may be positive integers. In various embodiments, the one or more ordered vectorized comparisons may include one or more single instruction multiple data (“SIMD”) instructions supported by the processor.

### FIELD

Embodiments of the present invention relate generally to the technical field of data processing, and more particularly, to vectorized pattern searching.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Multiple variants of the Boyer-Moore (“BM”) algorithm, such the Boyer-Moore-Horspool algorithm, may be used for pattern searching. Some BM algorithm variants may employ a lookup table (sometimes referred to as a “bad character table”) to determine a sliding window shift distance where the pattern is not found in a current sliding window, BM variants may perform granular comparisons of data with the pattern, e.g., byte-to-byte or N-gram data unit to N-gram data unit, to determine whether a match is found. The sliding window shift distance in BM variants may be limited by a length of the pattern.

Vectorized comparison instructions (also referred to as “primitives”) have been implemented in various libraries, e.g., as single instruction multiple data (“SIMD”) instructions. For example, Streaming SIMD Extension 4 (“SSE4”) for certain Intel® architecture processors, and particularly SSE4.2, includes SIMD instructions that perform character searches and comparisons on two operands of a particular number of bytes (e.g., sixteen) at a time.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates an example vectorized pattern searching technique, in accordance with various embodiments.

FIG. 2 schematically illustrates an example method that may be implemented by a processor of a computing device to perform the vectorized pattern searching technique of FIG. 1, in accordance with various embodiments.

FIG. 3 schematically illustrates another example vectorized pattern searching technique, in accordance with various embodiments.

FIG. 4 schematically illustrates an example method that may be implemented by a processor of a computing device to perform the vectorized pattern searching technique of FIG. 3, in accordance with various embodiments.

FIG. 5 schematically illustrates yet another example vectorized pattern searching technique, in accordance with various embodiments.

FIG. 6 schematically illustrates an example method that may be implemented by a processor of a computing device to perform the vectorized pattern searching technique of FIG. 5, in accordance with various embodiments.

FIG. 7 schematically depicts an example computing device on which disclosed methods and computer-readable media may be implemented, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the terms “module” and/or “logic” may refer to, be part of, or include an Application Specific Integrated Circuit (“ASIC”), an electronic circuit, a processor (shared, dedicated, or group) and/or memory (shared, dedicated, or group) that execute one or more software or firmware programs, a combinational logic circuit, and/or other suitable components that provide the described functionality.

As noted in the background, there are multiple variants of the Boyer-Moore (“BM”) algorithm. Many BM variants operate in accordance with the following abstract pseudo code:

```
create bad character table;
[optionally, create second table;]
set sliding window to beginning of data to be searched;
do
      if tail verification fails {
          use bad character table to determine shift distance of
          sliding window, and shift sliding window;
      } else { //tail verification passes
          perform various operations to determine whether there
          is a complete pattern match;
          return pattern found or shift sliding window;
      }
until pattern found or no more data to be searched;
```

The “various operations” that may be performed to determine whether there is a complete pattern match may vary according to the variant of BM being used, and are not material for this disclosure. Moreover, assuming a complete pattern match is not found after tail verification passes, the sliding window may be shifted in conventional ways, including but not limited to shifting the sliding window one data unit (e.g., as may be done in the Boyer-Moore-Horspool algorithm), or by implementing a second table that predicts the shift distance after a multi-data-point-partial-match false verification.

Conventional BM variants use scalar comparators to scan for a pattern match. This may limit a shift distance between consecutive sliding windows to no more than a length m of a search pattern P. Moreover, data units such as bytes or N-grams may be compared one at a time, which may cause pattern searching performance to be, at best, linear with the pattern length.

Additionally, in conventional BM variants, the shift distances predicted by the bad-character table in the event of a tail-verification error are often less than the pattern length m. BM techniques that reduce sliding window shift distances, e.g., to one data unit, may cause a reduction of maximum shift distance and higher cost in data access latency.

Accordingly, various methods and techniques are described herein for performing vectorized searches to locate a pattern P having a length m within a set of data T. In various embodiments, the vectorized search may include a shift of a sliding window into T by a distance d that is greater than m on determination, based on one or more ordered vectorized comparisons of portions of P and T, that no potential match of P is found within the sliding window. An “ordered vector comparison” may refer to any multi-data unit comparison that occurs in a particular order. For example, “forward” and “reverse” vector comparisons are discussed herein.

In various embodiments, the one or more ordered vectorized comparisons may include one or more SIMD instructions supported by a processor. These vectorized SIMD instructions may be incorporated into BM variants in various ways in order to speed up pattern searching. For example, a number of “false positives” may be reduced from that which might be found using non-vectorized instructions, e.g., instructions that compare one data unit at a time. Additionally or alternatively, the use of vectorized SIMD instructions may require fewer sliding window shifts than a non-vectorized BM pattern search, as the use of such vectorized instructions may enable sliding window shifts of a distance d that is greater than a length m of a search pattern P.

Various SIMD instructions may be utilized as vector comparisons. For instance, some processors, including processors manufactured by the Intel® Corporation of Santa Clara, Calif., may support streaming SIMD Extension 4 (“SSE4”) instructions, including SSE4.2 instructions. SSE4.2 instructions may perform character searches and comparisons on two operands of a particular number of bytes (e.g., 16) at a time. One example is PCMPESTRI, or “Packed Compare Explicit Length Strings.” This operation, which is an ordered comparison, may return an index within a data buffer (e.g., a sliding window) at which a potential pattern match begins. For example, a PCMPESTRI operation provided with a search pattern “GABCD” and a data buffer “ERGTYHABCDRGABCD” may return an index of 11.

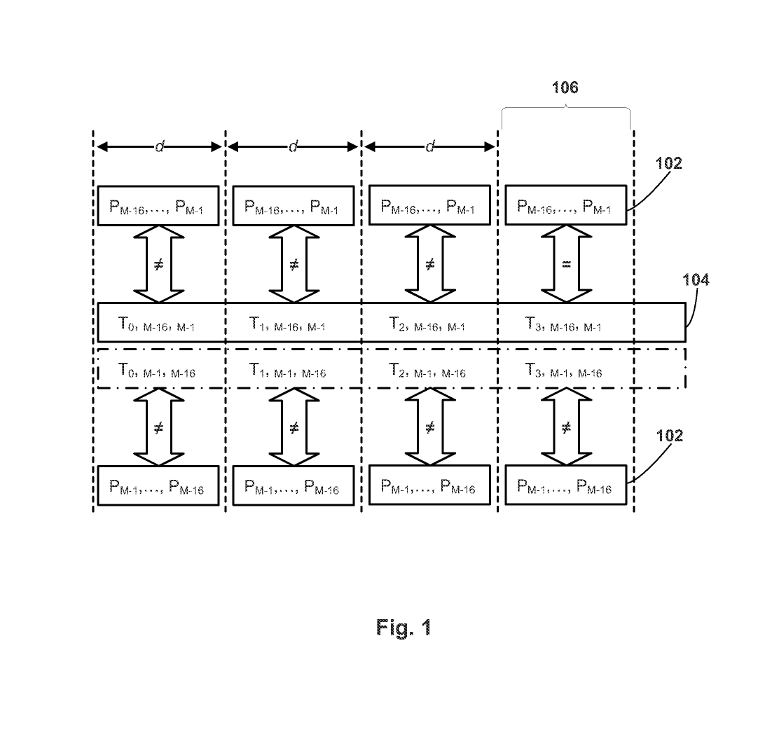

FIG. 1 schematically depicts one example technique for searching for a pattern P (indicated at 102) of a length m in a set of data T (indicated at 104). At the point in the pattern search shown in FIG. 1, three portions of T (T₀, T₁, T₂) were previously bounded by a sliding window and checked for potential matches of P using vectorized comparisons (with no matches found). For example, one or more ordered vectorized comparisons may have been performed within each portion of T to search for potential matches of P.

In various embodiments, the one or more vectorized comparisons may include forward vector comparisons and reverse vector comparisons. The forward vector comparisons are represented by the top arrows and the reverse vector comparisons are represented by the bottom arrows. In various embodiments, the forward and reverse vector comparisons may be between suffixes of P and T. For instance, in the first sliding window portion, T₀, a forward vector suffix comparison, e.g., using a SIMD instruction such as PCMPESTRI, was performed between a sixteen-byte suffix of P, m-6, m-1 and a sixteen-byte suffix of T₀, m-16, m-1. In this example and others described herein, the vector comparisons operate on sixteen bytes because many modern processors have registers capable of storing sixteen bytes. For example, PCMPESTRI may be capable of operating on sixteen bytes at a time. However, this is not meant to be limiting, and other sizes of vectors may be vector compared where registers of other sizes are available.

A reverse vector suffix comparison was also performed, e.g., using a SIMD instruction such as PCMPESTRI, in the first sliding window T₀ between a sixteen-byte suffix of P, m-16 and a sixteen-byte suffix of T₀, e.g., m-1, m-16. This is referred to as a “reverse” vector comparison because the suffixes of T₀ and P are compared in reverse (as indicated by the box enclosed by a dot-dash-dot perimeter line).

In various embodiments, the forward vector comparison may provide a 16-byte “safety zone” where the sliding window overlaps no more than 16 bytes of the suffix of P. In various embodiments, the reverse vector comparison may provide another safety zone, e.g., where the sliding window overshoots an instance of P by no more than 15 bytes.

In FIG. 1, the result of both vector comparisons in the sliding window T₀ was failure (as indicated by the “≠” symbols in the arrows). This may indicate that no potential match of P was found within the sliding window corresponding to T₀. As a result, the sliding window was shifted (to the right in FIG. 1) by a distance d, and the vector comparisons were performed again on the next portion of T, T₁.

In various embodiments, particularly where no potential match of P is found within a given sliding window, the sliding window shift distance d may be greater than the length m of P. For example, in some embodiments d may be equal to two times a width of the vectorized comparisons (e.g., a register length) supported by a processor of a computing system, minus one. The increased sliding window shift distance may lead to vectorized pattern searching being more efficient than conventional BM algorithm variants. For instance, using vectorized comparisons to compare multiple data units of the pattern P with multiple-data-units within each sliding window Tⱼ may reduce a likelihood that a sliding window will be shifted by smaller distances dictated by convention BM algorithm variants, e.g., by one data unit, or up to a length of a register, minus one data unit.

In various embodiments, including the example technique of FIG. 1, it may not be necessary to consult a had character table to determine a sliding window shift distance. Rather, so long as no potential matches of P are found in a current sliding window, a constant shift distance d may be used. In various embodiments, this sliding window shift distance d may be greater than the pattern length m. There also may be less sliding window shifts over an entire course of a pattern search performed as shown in FIG. 1 than there would be using conventional BM pattern searching algorithm. For example, there may be a reduced number of sliding window shifts by distances of one data unit and/or a register length minus one data unit. Accordingly, a pattern search performed as shown in FIG. 1 may require less overall sliding window shifts than a conventional BM pattern searching algorithm.

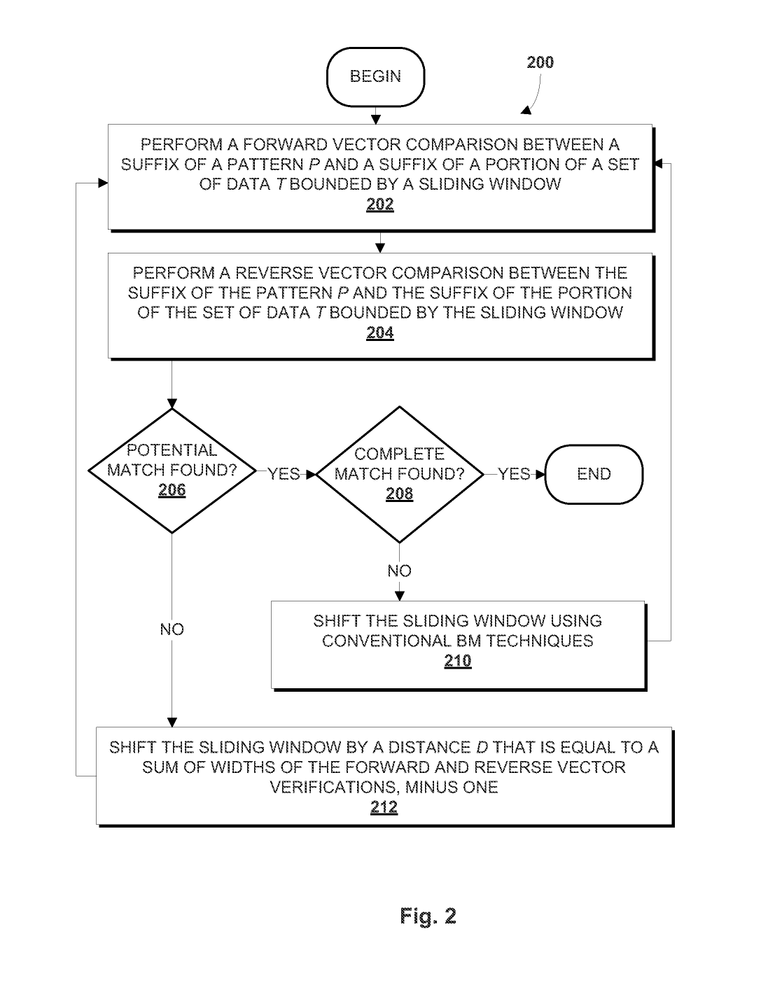

An example method 200 that may be implemented by a processor of a computing device to perform the searching technique of FIG. 1 is depicted in FIG. 2. At block 202, a forward vector comparison may be performed, e.g., by a processor of a computing device, between a suffix of the pattern P (e.g., P, m-1) and a suffix of a portion of the data T bounded by a sliding window (e.g., T, m-16, m-1). For instance, a processor of the computing device may perform a SIMD forward vector compare (e.g., PCMPESTRI). At block 204, a reverse vector suffix comparison may be performed, e.g., by a processor of a computing device. For instance, a processor of the computing device may perform a SIMD vector compare between reversed suffixes of the current sliding window and the pattern P.

At block 206, if a potential match for the pattern P is found by either the forward or reverse vector comparison, then it may be determined at block 208 whether there is a complete match. For instance, a strcmp or PCMPEQB SIMD instruction may be called to see if the potential match is a complete match, e.g., using convention BM techniques. If a complete match for the pattern P is found, then method 200 may end. If the potential match for the pattern P is not a complete match for the pattern P, however, then at block 210, the sliding window may be shifted by a distance that may be determined in various ways, e.g., using various BM-related techniques (e.g., shift by one, a second BM table predicting shift distance of a multi-data-point verification error, or a Knuth-Morris-Pratt technique).

Back at block 206, if no potential match for the pattern P is found, then at block 212, the sliding window may be shifted by a distance d that is greater than a length m of the pattern P, e.g., a sum of widths of the forward and reverse vector suffix comparisons, minus one. In various embodiments, the technique of FIG. 1 and method 200 may not require consultation of a bad character table to determine a sliding window shift distance.

In various embodiments, various numbers of forward and reverse vector comparisons (e.g., PCMPESTRI) may be used within a particular sliding window, depending on the length m of the pattern P. For instance, assume the vector comparison operation (e.g., PCMPESTRI) has a width of sixteen bytes. For 31≧m>17, a 16-byte suffix of P and a 16-byte suffix of the portion of T bounded by the sliding window may be vector compared, and then the reverse sequence of the same 16-byte sequences of P and T may be compared. If both forward and reverse vector comparisons return no potential match, then the sliding window shift distance may be d=31 (2×16−1). For 63≧m>32, two forward and two reverse vector comparisons may be used to compare the last thirty two bytes of the sliding window and P. If no match is found, then the sliding window may be shifted by d=63 (e.g., 4×16−1).

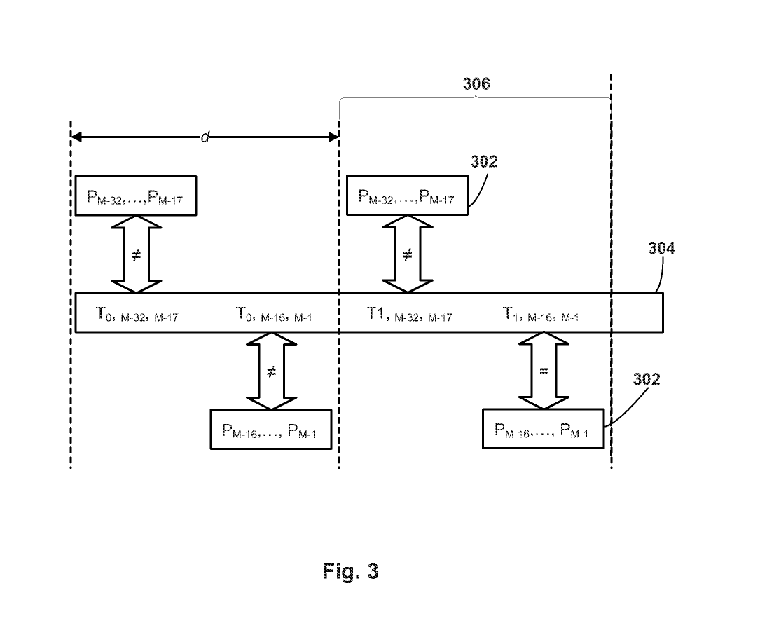

FIG. 3 schematically depicts another embodiment of vectorized pattern searching for a pattern P (302) in a set of data T (304). In this embodiment, two or more forward vector comparisons may be performed within each sliding window (a current sliding window is indicated at 306). In some cases, these two or more forward vector comparisons may be performed hack-to-back. In this example, the pattern P has a length m of thirty two bytes, though this is not required. The first sixteen bytes of the pattern P, m-32 to m-17, may be forward vector compared (e.g., using PCMPESTRI) to the first sixteen bytes of T within a sliding window. Similarly, the next sixteen bytes of the pattern P, m-16 to m-1, may be forward vector compared to the last sixteen bytes of T within the sliding window. If no potential match to P is found by either vector comparison, then the sliding window may be shifted by a distance d. In FIG. 3, a potential match has been found in the current sliding window 302, by the second forward vector comparison of bytes m-16 to m-1. In some embodiments, more than two back-to-back vector comparisons may be performed within a sliding window to increase its size, reducing a number of sliding window shifts.

In various embodiments, outputs of the two or more vector comparisons may be added and the sum used to determine whether a potential match for P was found within the sliding window. For instance, if the two vector comparisons are vectorized SIMD instructions, and the sum of their output is equal to 32, that may indicate that no potential match was present in the current sliding window. In such case, the sliding window may be shifted by d=31 (2×16−1). If the sum of the outputs of the two ordered comparisons is between zero and thirty one, however, then various actions may be taken to determine whether there is a complete match. For example, a series of ordered vector comparisons may be performed to determine whether a potential match for P is present. If the sum of the outputs of the two or more ordered comparisons is equal to zero, that may indicate a possible exact match. In such case, a comparison of the remaining data units in the sliding window (e.g., using strew or PCMPEQB) may be performed to determine whether there is truly a match.

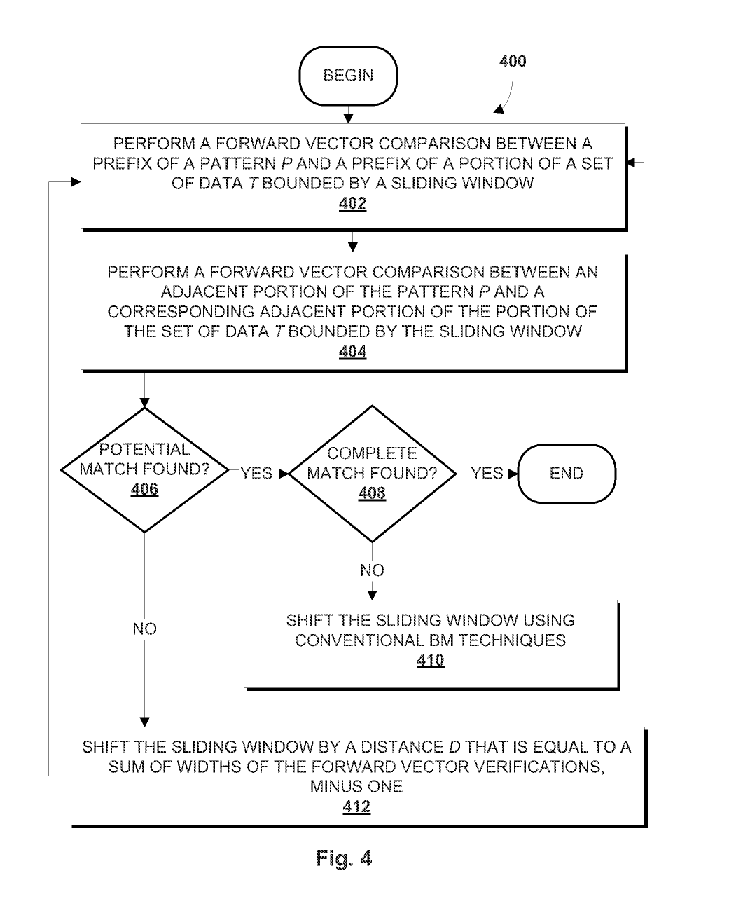

FIG. 4 depicts an example method 400 that may be implemented by a processor of a computing device to perform the searching technique of FIG. 3, in accordance with various embodiments. Method 400 may be similar to method 200 in many respects. However, at block 402, rather than performing a forward vector comparison between a suffix of the pattern P and a suffix of a portion of a set of data T bounded by a sliding window, a forward vector comparison may be performed between a prefix of the pattern P (e.g., bytes 0:15) and a prefix of the portion of a set of data T bounded by the sliding window. Similarly, at block 404, rather than performing a reverse vector comparison between a suffix of the pattern P and a suffix of a portion of a set of data T bounded by a sliding window, another forward vector comparison may be performed between an adjacent portion of the pattern P (e.g., bytes 16:m-1) and an adjacent portion (e.g., bytes 16:31) of the portion of the set of data T bounded by the sliding window. As was the case with the technique of FIGS. 1-2, the technique of FIG. 3 and method 400 may not require consultation of a had character table to determine a sliding window shift distance where no potential matches to P are found within a sliding window.

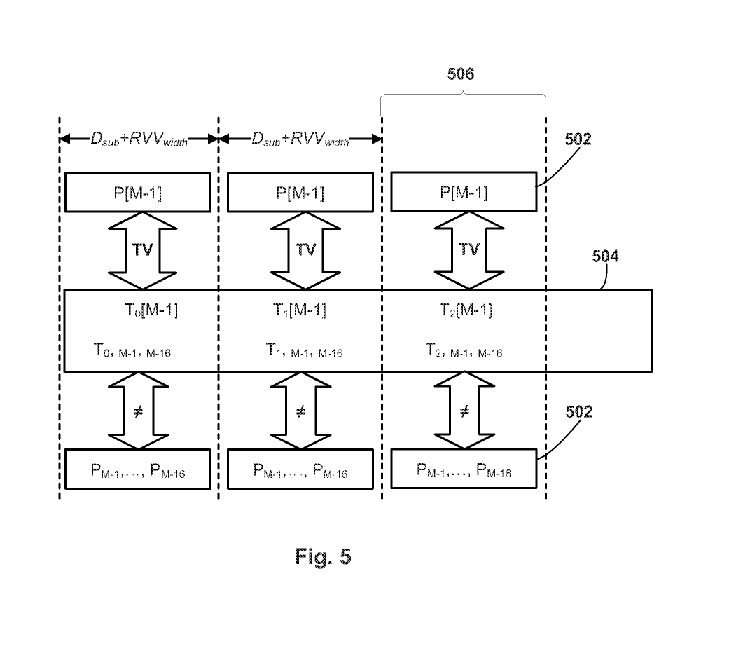

FIG. 5 schematically depicts another example technique of vectorized searching for a pattern P 502 of length m a set of data T 504. In this embodiment, a scalar tail verification of byte or N-grain (indicated by the top arrows labeled “TV”) may be performed in conjunction with a reverse vector suffix comparison. In various embodiments, on tail verification failure, a had character table may be consulted to determine a subdistance d_{sub} to shift a sliding window. However, instead of only shifting the sliding window d_{sub}, the sliding window may be shifted a distance d that is equal to a sum of d_{sub} and a width of the reverse vector suffix comparison. For instance, if the reverse vector comparison operation has a width RVV_{width} of sixteen bytes, then the shift distance d may be equal to d_{sub}+15 for byte-granular tail verification or d_{sub}+14 for 16-bit N-gram=2 tail verification.

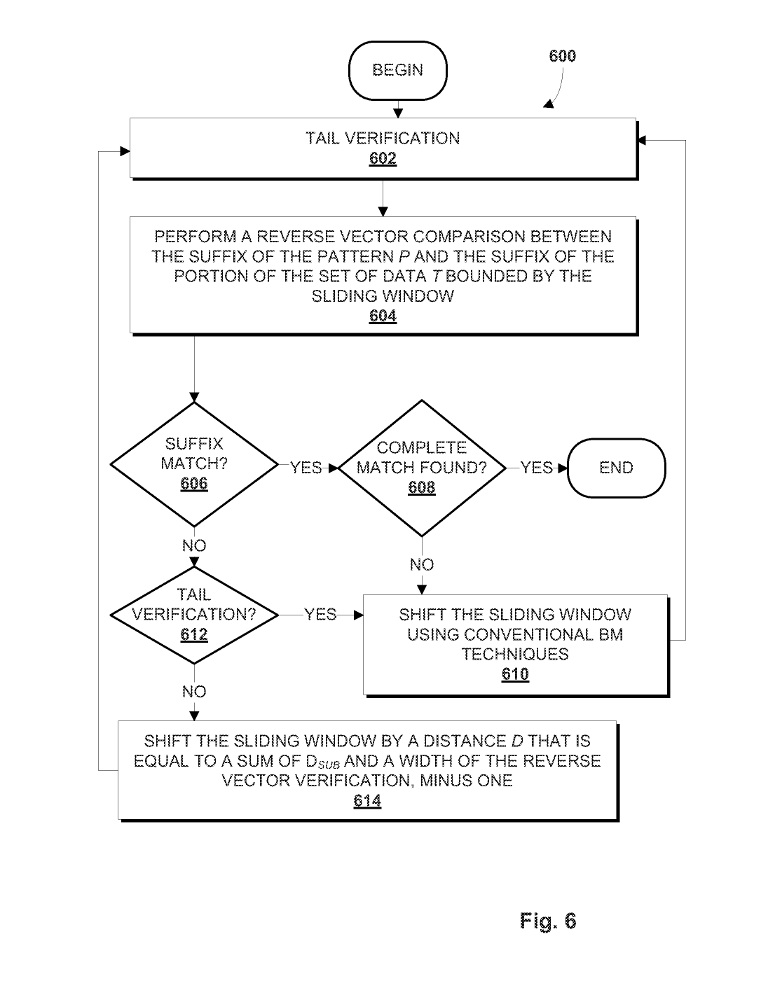

FIG. 6 depicts an example method 600 that may be implemented by a processor of a computing device to locate a pattern P of a length m in a set of data T in the manner shown in FIG. 5. At block 602, a tail verification may be performed between a tail of P of desired N-gram data unit (e.g., P[m-1] for 1-gram) and a tail of a portion of T bounded by a current sliding window 506. At block 604, a reverse vector suffix comparison may be performed, e.g., in parallel with the tail verification of block 602. At block 606, if a suffix match is found as a result of the reverse vector comparison, then method may proceed to block 608. If at block 608 a complete match is found (e.g., using strcmp or PCMPEQB), then method 600 may end. However, at block 608, if no complete match is found, then the sliding window may be shifted by convention BM techniques at block 610.

Back at block 606, if a potential suffix match is not found, then method may proceed to block 612. If the tail verification of block 602 was successful, then method 600 may proceed from block 612 to block 610, and the sliding window may be shifted using conventional BM techniques. However, if the tail verification of block 602 was not successful, then method 600 may proceed to block 614, where the subdistance d_{sub} predicted by the bad character table may be combined with a width RVV_{width} to determine the shift distance for the next sliding window. Method 600 may then repeat until a pattern is found or there is no more data to search.

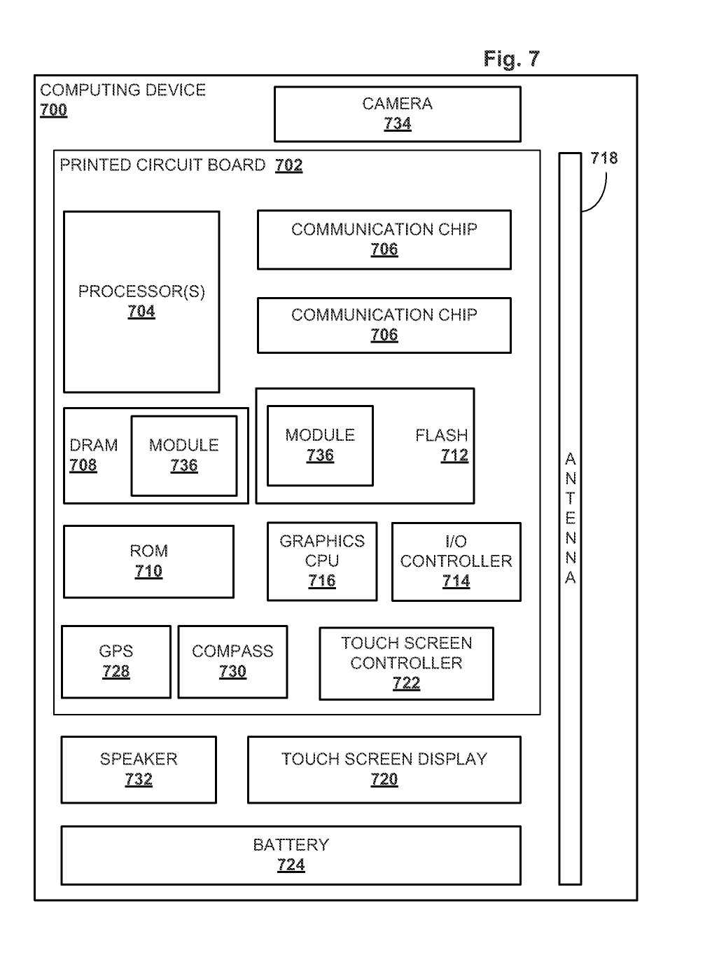

FIG. 7 illustrates an example computing device 700, in accordance with various embodiments. Computing device 700 may include a number of components, a processor 704 and at least one communication chip 706. In various embodiments, the processor 704 may be a processor core. In various embodiments, the at least one communication chip 706 may also be physically and electrically coupled to the processor 704, further implementations, the communication chip 706 may be part of the processor 704. In various embodiments, computing device 700 may include a printed circuit board (“PCB”) 702. For these embodiments, processor 704 and communication chip 706 may be disposed thereon. In alternate embodiments, the various components may be coupled without the employment of PCB 702.

Depending on its applications; computing device 700 may include other components that may or may not be physically and electrically coupled to the PCB 702. These other components include, but are not limited to, volatile memory (e.g., dynamic random access memory 708, also referred to as “DRAM”), non-volatile memory (e.g., read only memory 710, also referred to as “ROM”), flash memory 712, an input/output controller 714, a digital signal processor (not shown), a crypto processor (not shown), a graphics processor 716, one or more antenna 718, a display (not shown), a touch screen display 720, a touch screen controller 722, a battery 724, an audio codec (not shown), a video codec (not shown), a global positioning system (“GPS”) device 728, a compass 730, an accelerometer (not shown), a gyroscope (not shown), a speaker 732, a camera 734, and a mass storage device (such as hard disk drive, a solid state drive, compact disk (“CD”), digital versatile disk (“DVD”))(not shown), and so forth. In various embodiments, the processor 704 may be integrated on the same die with other components to form a System on Chip (“SoC”).

In various embodiments, volatile memory (e.g., DRAM 708), non-volatile memory (e.g., ROM 710), flash memory 712, and the mass storage device may include programming instructions configured to enable computing device 700, in response to execution by processor(s) 704, to practice all or selected aspects of methods 200, 400 and/or 600. For example, one or more of the memory components such as volatile memory (e.g., DRAM 708), non-volatile memory (e.g., ROM 710), flash memory 712, and the mass storage device may include temporal and/or persistent copies of instructions that, when executed, enable computing device 700 to operate a module 736 configured to practice all or selected aspects of methods 200, 400 and/or 600. Module 736 may e.g., be a callable function of an application (not shown), a system service of an operating system (not shown), and so forth. In alternate embodiments, module 736 may be a co-processor or an embedded microcontroller.

The communication chips 706 may enable wired and/or wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. Most of the embodiments described herein include WiFi and cellular radio interfaces as examples. However, the communication chip 706 may implement any of a number of wireless standards or protocols, including but not limited to IEEE 802.16 (“WiMAX”), IEEE 702.20, Long Term evolution (“LTE”), General Packet Radio Service (“GPRS”), Evolution Data Optimized (“Ev-DO”), Evolved High Speed Packet Access (“HSPA+”), Evolved High Speed Downlink Packet Access (“HSDPA+”), Evolved High Speed Uplink Packet Access (“HSUPA+”), Global System for Mobile Communications (“GSM”), Enhanced Data rates for GSM Evolution (“EDGE”), Code Division Multiple Access (“CDMA”), Time Division Multiple Access (“TDMA”), Digital Enhanced Cordless Telecommunications (“DECT”), Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev-DO, and others.

In various implementations, the computing device 700 may be a laptop, a netbook, a notebook, an ultrabook, a smart phone, a computing tablet, a personal digital assistant (“PDA”), an ultra mobile PC, a mobile phone, a desktop computer, a server, a printer, a scanner, a monitor, a set-top box, an entertainment control unit (e.g., a gaming console), a digital camera, a portable music player, or a digital video recorder. In further implementations, the computing device 700 may be any other electronic device that processes data.

Embodiments of apparatus, packages, computer-implemented methods, systems, devices, and computer-readable media (transitory and non-transitory) are described herein for vectorized searching for a pattern P within a set of data T, the pattern P having a length m. In various embodiments, the search may include a shift of a sliding window into T by a distance d that is greater than m on determination, based on one or more ordered vectorized comparisons of portions of P and T, that no potential match of P is found within the sliding window. In various embodiments, d and in may be positive integers. In various embodiments, the one or more vectorized comparisons may include one or more SIMD instructions supported by a processor.

In various embodiments, the one or more ordered vectorized comparisons may include a forward vector comparison and a reverse vector comparison. In various embodiments, the forward and reverse vector comparisons may be suffix comparisons.

In various embodiments, the one or more ordered vector comparisons may include at least two forward vector comparisons. In various embodiments, the at least two forward vector comparisons may be performed back-to-back. In various embodiments, the at least two forward vector comparisons may include a vectorized comparison of a first portion of P with a first portion of T within the sliding window and a vectorized comparison of a second portion of/, with a second portion of T within the sliding window.

In various embodiments, the one or more ordered vectorized comparisons may include a reverse vector comparison, and the vectorized search may include a tail comparison. In various embodiments, the reverse vector comparison may be a suffix comparison. In various embodiments, the tail comparison may be used in conjunction with a bad character table to determine a sub-distance d_{sub}. In various embodiments, d may be a sum of d_{sub} and a width of the reverse vector comparison minus one when no potential matches to P are found by the reverse vector comparison.

In various embodiments, the one or more ordered vectorized comparisons may have a width w. In various embodiments, w may be an integer greater than zero. In various embodiments, d may be equal to (w×2)−1. In various embodiments, the one or more ordered vectorized comparisons may include vectorized comparisons using a SIMD instruction supported by the processor.

Although certain embodiments have been illustrated and described herein for purposes of description, this application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. At least one non-transitory computer-readable medium comprising instructions that, in response to execution by a processor of a computing device, enable the computing device to facilitate a vectorized search for a pattern P within a set of data T, the pattern P having a length m, wherein the search includes a shift of a sliding window into T by a distance d that is greater than m on determination, based on one or more ordered vectorized comparisons of portions of P and T, that no potential match of P is found within the sliding window, wherein d and m are positive integers, and wherein the one or more ordered vectorized comparisons include one or more single instruction multiple data (“SIMD”) instructions supported by the processor.

2. The at least one non-transitory computer-readable medium of claim 1, wherein the one or more ordered vectorized comparisons comprise a forward vector comparison and a reverse vector comparison.

3. The at least one non-transitory computer-readable medium of claim 2, wherein the forward and reverse vector comparisons comprise suffix comparisons.

4. The at least one non-transitory computer-readable medium of claim 1, wherein the one or more ordered vector comparisons comprise at least two forward vector comparisons.

5. The at least one non-transitory computer-readable medium of claim 4, wherein the at least two forward vector comparisons are performed back-to-back.

6. The at least one non-transitory computer-readable medium of claim 4, wherein the at least two forward vector comparisons comprise an ordered comparison of a first portion of P with a first portion of T within the sliding window and an ordered comparison of a second portion of P with a second portion of T within the sliding window.

7. The at least one non-transitory computer-readable medium of claim 1, wherein the one or more ordered vectorized comparisons comprise a reverse vector comparison, and the vectorized search comprises a tail comparison.

8. The at least one non-transitory computer-readable medium of claim 7, wherein the reverse vector comparison comprises a suffix comparison.

9. The at least one non-transitory computer-readable medium of claim 7, wherein the tail comparison is used in conjunction with a bad character table to determine a sub-distance d_{sub}.

10. The at least one non-transitory computer-readable medium of claim 9, wherein d is a sum of d_{sub} and a width of the reverse vector comparison minus one when no potential matches to P are found by the reverse vector comparison.

11. The at least one non-transitory computer-readable medium of claim 1, wherein the one or more ordered vectorized comparisons have a width w, d is equal to (w×2)−1, and w is an integer greater than zero.

12. The at least one non-transitory computer-readable medium of claim 1, wherein the one or more ordered vectorized comparisons comprise ordered vectorized comparisons a SIMD instruction supported by the processor.

13. A computer-implemented method, comprising:
searching, by a computing device, for a pattern P within a portion of a set of data T bounded by a sliding window into T using one or more vectorized comparisons, the pattern P having a length m, m being a positive integer; and
shifting, by the computing device, the sliding window by a distance d that is greater than m on determination that the one or more vectorized comparisons did not find a potential match of P within the portion of T bounded by the sliding window, wherein d is a positive integer.

14. The computer-implemented method of claim 13, wherein the one or more vectorized comparisons comprise one or more single instruction multiple data (“SIMD”) instructions supported by a processor of the computing device.

15. The computer-implemented method of claim 13, wherein the one or more vectorized comparisons comprise a forward vector comparison and a reverse vector comparison.

16. The computer-implemented method of claim 15, wherein the forward and reverse vector comparisons comprise suffix verifications.

17. The computer-implemented method of claim 13, wherein the one or more vector comparisons comprise at least two forward vector comparisons.

18. The computer-implemented method of claim 17, wherein the at least two forward vector comparisons are performed back-to-back.

19. The computer-implemented method of claim 17, wherein the at least two forward vector comparisons comprise an ordered comparison of a first subset of P with a first subset of T bounded by the sliding window and an ordered comparison of a second subset of P with a second subset of T bounded by the sliding window.

20. The computer-implemented method of claim 13, wherein the one or more vectorized comparisons comprise a reverse vector comparison, the method further comprising performing, by the computing device, within the portion of T bounded by the sliding window, a tail verification.

21. The computer-implemented method of claim 20, wherein the reverse vector comparison comprises a suffix comparison.

22. The computer-implemented method of claim 20, wherein a had character table is consulted to determine a sub-distance d_{sub}.

23. The computer-implemented method of claim 22 wherein d is a sum of d_{sub} and a width of the reverse vector comparison minus one when no potential matches to P are found by the reverse vector comparison.

24. A system, comprising:
one or more processors; and
a module configured to be operated with or by the one or more processors to:
search for a pattern P of a length m within a portion of a set of data T bounded by a sliding window into T using one or more vectorized comparisons, wherein m is a positive integer, and wherein the one or more vectorized comparisons include one or more single instruction multiple data (“SIMD”) instructions supported by the processor; and
shift the sliding window by a distance d that is greater than m on determination that the one or more vectorized comparisons did not find a potential match of P within the portion of T bounded by the sliding window, wherein d is a positive integer.

25. The system of claim 24, wherein the one or more vectorized comparisons comprise a forward vector suffix comparison and a reverse vector suffix comparison.

26. The system of claim 24, wherein the one or more vectorized comparisons comprise a reverse vector suffix comparison, and the module is further configured to perform, within the portion of T bounded by the sliding window, a tail verification, wherein the tail verification is performed in conjunction with a bad character table to determine a sub-distance d_{sub}, and wherein d is a sum of d_{sub} and a width of the reverse vector suffix comparison minus one when no potential matches to P are found by the reverse vector suffix comparison.

27. The system of claim 24, wherein the one or more vectorized comparisons comprise vectorized comparisons using a SIMD instruction supported by the processor.

28. The system of claim 24, further comprising a touch screen display.
